(19) United States
(12) Patent Application Publication
(10) Pub. No.: US 2015/0221334 A1
(43) Pub. Date: Aug. 6, 2015

(54) AUDIO CAPTURE FOR MULTI POINT IMAGE CAPTURE SYSTEMS

(71) Applicant: LiveStage°, Inc., New York, NY (US)

(72) Inventors: Kristopher King, Hermosa Beach, CA (US); Jeff Prosserman, New York, NY (US)

(21) Appl. No.: 14/689,922

(22) Filed: Apr. 17, 2015

Related U.S. Application Data
(63) Continuation-in-part of application No. 14/687,752, filed on Apr. 15, 2015.
Application No. 14/687,752 is a continuation-in-part of application No. 14/532,659, filed on Nov. 4, 2014.
Application No. 14/532,659 is a continuation-in-part of application No. 14/096,869, filed on Dec. 4, 2013.
(60) Provisional application No. 61/981,817, filed on Apr. 20, 2014.
(60) Provisional application No. 61/981,416, filed on Apr. 18, 2014.
(60) Provisional application No. 61/900,093, filed on Nov. 5, 2013.
(60) Provisional application No. 61/900,093, filed on Nov. 5, 2013.

(51) Int. Cl. G11B 20/10; H04R 5/04; G06F 3/16

(52) U.S. Cl. CPC G11B 20/10527; G06F 3/162; H04R 5/04; G11B 2020/10546

(57) ABSTRACT

The present invention provides methods and apparatus for designing audio capture orientations for specific performance venues and manners of presenting designs for audio capture at specific venues.

### CROSS REFERENCE TO RELATED APPLICATION

This application claims the benefit of the U.S. Provisional Application Ser. No. 61/981,817 filed on Apr. 20, 2014. This application claims priority to the U.S. Non-Provisional patent application Ser. No. 14/687,752, filed on Apr. 15, 2015 and entitled “VENUE SPECIFIC MULTI POINT IMAGE CAPTURE” as a Continuation in Part patent application. The application Ser. No. 14/687,752 in turn claims the benefit of U.S. Provisional Application Ser. No. 61/981,416 filed on Apr. 18, 2014. This application claims priority to the U.S. Non-Provisional patent application Ser. No. 14/532,659, filed on Nov. 4, 2014 and entitled SWITCHABLE MULTIPLE VIDEO TRACK PLATFORM as a Continuation in Part patent application. The application Ser. No. 14/532,659 claims the benefit of the U.S. Provisional Application Ser. No. 61/900,093 filed on Nov. 5, 2013. The contents of each are relied upon and hereby incorporated by reference.

### FIELD OF THE INVENTION

The present invention relates to methods and apparatus for generating streaming video captured from multiple vantage points. More specifically, the present invention presents methods and apparatus for the process of designing the placement of apparatus for capturing audio data in various formats and from multiple disparate points of capture based on venue specific characteristics, wherein the assembling of the captured audio data into an audio experience may emulating observance of an event from at least two of the multiple points of capture in specifically chosen locations of a particular venue.

### BACKGROUND OF THE INVENTION

Traditional methods of viewing image data generally include viewing a video stream of images in a sequential format. The viewer is presented with image data from a single vantage point at a time. Simple video includes streaming of imagery captured from a single image data capture device, such as a video camera. More sophisticated productions include sequential viewing of image data captured from more than one vantage point and may include viewing image data captured from more than one image data capture device.

As video capture has proliferated, popular video viewing forums, such as YouTube™, have arisen to allow for users to choose from a variety of video segments. In many cases, a single event will be captured on video by more than one user and each user will post a video segment on YouTube. Consequently, it is possible for a viewer to view a single event from different vantage points, However, in each instance of the prior art, a viewer must watch a video segment from the perspective of the video capture device, and cannot switch between views in a synchronized fashion during video replay. As well, the location of the viewing positions may in general be collected in a relatively random fashion from positions in a particular venue where video was collected and made available ad hoc. It may be typical that such recordings may also include audio tracks.

Consequently, alternative ways of proactively designing specific location patterns for the collection of audio data that may be combined and processed into a collection of venue specific video segments that may subsequently be controlled by a viewer are desirable.

### SUMMARY OF THE INVENTION

Accordingly, the present invention provides methods and apparatus for designing specific location patterns for the collection of audio data in a venue specific manner.

The audio data captured from multiple vantage points may be captured as one or both of: omni-directional audio data or directional audio data. The data is synchronized such that a user may perceive audio data from multiple vantage points, each vantage point being associated with a disparate audio capture device. The data is synchronized such that the user may perceive audio data of an event or subject at an instance in time, or during a specific time sequence, from one or more vantage points.

In some embodiments, locations of audio capture apparatus may be designed in a venue specific manner based on the design aspects of a particular venue and the stage setting that is placed within the venue. It may be desirable to provide a user with multiple audio capture sequences from different locations in the particular venue. One or more of stage level, back stage, orchestra, balcony and standard named locations may be included in the set of locations for audio capture apparatus. It may also be desirable to select design locations for audio capture based upon a view path from a particular location to a desired focal perspective such as a typical location for a performer or participant, the location of performing equipment or a focal point for activity of a performer or performers. In other embodiments, the location of design locations may relate to a desired perspective relating to locations of spectators at an event.

In some exemplary embodiments, the designed locations of the audio capture apparatus may be superimposed upon a spatial representation of a specific venue. Characteristics of the location including, the type of audio capture device at the location, a positional reference relating to a seating reference in seating zones, or spatial parameters including distances, heights and directional information may also be presented to a user upon the superimposed spatial representation. In some embodiments, the spatial representation or virtual representation may include depictions of designed locations superimposed upon graphic representations of a venue and may be presented to a user upon a graphical display apparatus of a workstation.

In some embodiments, the virtual representation may include graphical and audio playback depictions of the sound that may be observed from a design location. The virtual representation may include a line of sight depiction of the audio path to a focal point in the venue, or in other embodiments may allow for a flexible representation of a typical sound in a set of different directional vectors from a design point. In other embodiments, the virtual representation may be chosen from a user selectable spectrum of directional possibilities. The virtual representation may in some embodiments include computer generated simulations of the sound. In other embodiments, actual audio data may be used to provide the virtual representation of the sound from a design location.

In additional embodiments, the specific placement of audio capture apparatus within a zonal region of a venue may be influenced by venue specific characteristic including but not limited to the shape and other characteristics of zones for spectators such as seating arrangement in the zone. In some embodiments, the location of obstructions such as columns, speakers, railings, and other venue specific aspects may influence the design for placement of audio capture apparatus. In other embodiments, the location of audio collection points that are not typically accessible to spectators may be included in the design of venue specific audio capture device placement.

In some embodiments, the placement of designed locations for audio capture devices may be based upon venue specific historical data. The venue specific historical data may include the historical demand for a seating location. The demand may relate to rapidity that a location is purchased for a typical class of performances, the frequency of occupation of a particular location or a quantification of historical occupation of the location during events, as non-limiting examples. In other examples, the historical data that may be used may include historical prices of tickets paid in a primary or secondary market environment.

In some embodiments, the placement of design locations for audio capture may be based upon venue specific preferences collected from spectator groups. In some embodiments, venue specific preferences may be collected by surveying spectator groups. In other embodiments, a preference election may be solicited in an interactive manner from spectator groups including in a non-limiting perspective by internet based preference collection mechanisms. A virtual representation of a venue along with the design for a stage or other performance location and historical or designed audio capture locations may be utilized in the acquisition of spectator preference collection in some embodiments.

In some embodiments, an array of audio capture devices may be designed and placed within the venue. The array may contain two or more of omni-directional audio collection devices and directional audio collection devices. The array may be designed as a rectilinear pattern, a radial pattern or numerous other patterns that may include irregular spacing between the microphones. The array may be characterized in the venue after set up by various calibration means that may include the playing of defined emanations of sound from focal points for the array while the array collects the data. The performance of the calibration protocol may allow for extraction of calibration factors for the array in the specific venue. The calibration may be performed in some embodiments before or after a performance, or in some embodiments it may be performed during the performance. The calibration may be performed at sound regimes that may not be perceived by the audience in some embodiments.

In some embodiments the recorded data from an array of microphones may be used to synthesize an audio track with various characteristics. The synthesis may combine captured data from selected microphones, and the combination may weight the signal from different locations in a different manner to create different effects. A common time synchronism amongst the array may allow for time dependent algorithms to be applied to synthesize audio tracks.

One general aspect includes a method of capturing venue specific audio recordings of an event, the method including the steps of: obtaining spatial reference data for a specific venue. The method also includes creating a digital model of the specific venue. The method also includes selecting multiple vantage points for audio capture in the specific venue. The method also includes placing two or more of omni-directional audio capture devices and directional audio capture devices at selected multiple vantage points, where the data is synchronized such that a user may listen to audio data from the multiple vantage points.

Implementations may include one or more of the following features: presenting the digital model to a first user, where the presentation supports the selecting multiple vantage points for audio capture. The method where the presentation includes venue specific aspects. The method where the venue specific aspects include one or more of seating locations, aisle locations, obstructions to viewing, performance venue layout, sound control apparatus, sound projection apparatus, and lighting control apparatus. The method where the selecting multiple vantage points is performed by interacting with a graphical display apparatus, where the interacting involves placement of a cursor location and selecting of the location with a user action. The method where the user action includes one or more of clicking a mouse, clicking a switch on a stylus, engaging a keystroke, or providing a verbal command. The method additionally including the step of presenting the digital model to a second user, where the second user employs the digital model to locate selected audio capture locations in the venue.

Implementations may include one or more of the following features: recording audio data from a selected audio capture location. The method may also include utilizing a soundboard to mix collected audio data with image data. The method may also include performing on demand post processing on audio and image data in a broadcast truck. The method may additionally include the step of communicating data from the broadcast truck utilizing a satellite uplink. The method may additionally include the step of transmitting at least a first stream of audio data to a content delivery network. The method may additionally include obtaining venue specific historical data. The method where the venue specific historical data includes one or more parameters relating to primary price, secondary price, frequency of occupation, and rate of purchase. The method where the venue specific historical data is used to create a first graphical layer of the model. The method additionally including a step of choosing audio capture locations in the venue utilizing the first graphical layer. The method where the step of choosing audio capture locations in the venue utilizing the presentation of the graphical layer is performed automatically.

Implementations may include one or more of the following features. For example, the method may include processing the at least two collected audio data with an algorithm to synthesize a second audio track. The method may include implementations where the algorithm weights the audio signal from a first audio data at a different level than the audio signal from a second audio data from the at least two collected audio data signals. The method may include implementations where the algorithm utilizes the time based index of the audio signal from a first audio data and the time based index of the audio signal from a second audio data from the at least two collected audio data signals.

One general aspect includes a method of collecting audio information from a performance, the method may include configuring an array of audio collection devices in a venue. The method also includes synchronizing a collection of audio data from two or more of the audio collection devices in the array to a time based index. The method also includes recording audio signals and synchronization signals from at least two of the audio collection devices from the array.

Implementations may include one or more of the following features. The method may additionally include processing the at least two collected audio data with an algorithm to synthesize a second audio track. The method may include implementations where the algorithm weights the audio signal from a first audio data at a different level than the audio signal from a second audio data from the at least two collected audio data signals. The method may include implementations where the algorithm utilizes the time based index of the audio signal from a first audio data and the time based index of the audio signal from a second audio data from the at least two collected audio data signals.

One general aspect includes a method of capturing venue specific audio of an event, the method including obtaining spatial reference data for a specific venue and creating a digital model of the specific venue. The method also includes presenting the digital model to a first user; selecting multiple vantage points for audio capture in the specific venue, where the presenting the digital model supports the selecting multiple vantage points for audio capture in the specific venue; placing two or more of omni-directional audio capture devices and directional audio capture devices at selected multiple vantage points; where the data is synchronized such that a user may perceive audio data from the multiple vantage points; recording audio data from selected audio capture locations; utilizing a soundboard to mix collected audio data with image data; performing on demand post processing on audio and image data in a broadcast truck; and communicating data from the broadcast truck utilizing a satellite uplink. The method also includes transmitting at least a first stream of audio data to a content delivery network.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 illustrates a block diagram of Content Delivery Workflow according to some embodiments of the present invention.

FIG. 2A illustrates the parameters influencing placement of audio capture devices in an exemplary stadium venue.

FIG. 2B illustrates the parameters influencing placement of audio capture devices in an exemplary big room venue.

FIG. 3 illustrates an exemplary spatial representation of located audio capture devices on a venue representation with location information.

FIG. 4 illustrates an exemplary virtual representation at a located audio capture device.

FIG. 5 illustrates exemplary venue specific aspects and features that may relate to some embodiments of the present invention as well as an array based location of audio sensing devices that may relate to some embodiments of the present invention.

FIG. 6 illustrates an exemplary representation of how a weighted combination of the time dependent audio recordings of a portion of an array may be utilized to synthesize the audio result at a position along a direction.

FIG. 7 illustrates different types of audio signals that may be captured according to some embodiments of the present invention.

FIG. 8 illustrates apparatus that may be used to implement aspects of the present invention including executable software.

### DETAILED DESCRIPTION

The present invention provides generally for the use of multiple audio microphones and arrays of audio microphones for the capture and processing of audio data that may be used to generate visualizations of live performance sound along with imagery from a multi-perspective reference. More specifically, the visualizations of the live performance sound imagery can include immersive in location sound that couples performance audio output with ambient sound from a venue location. The ambient sound could include live sound reactions from audience members and sound effects based on the acoustics of a venue location as non limiting examples. Audio data captured via the multiple camera arrays is synchronized and made available to a user via a communications network. The user may choose an audio vantage point from the multiple audio locations for a particular instance of time or time segment. In some embodiments, the audio locations may be collocated with video capture equipment while in others there may be a mixture of audio only capture locations and simultaneous audio and video capture locations. Arrays of audio capture devices may be deployed to capture synchronized audio data in designed grid patterns which may be used in algorithmic treatments to synthesize audio tracks for various representations.

In the following sections, detailed descriptions of embodiments and methods of the invention will be given. The description of both preferred and alternative embodiments though through are exemplary only, and it is understood that to those skilled in the art that variations, modifications and alterations may be apparent. It is therefore to be understood that the exemplary embodiments do not limit the broadness of the aspects of the underlying invention as defined by the claims.

### DEFINITIONS

As used herein “Broadcast Truck” refers to a vehicle transportable from a first location to a second location with electronic equipment capable of transmitting captured image data, audio data and video data in an electronic format, wherein the transmission is to a location remote from the location of the Broadcast Truck.

As used herein, “Image Capture Device” refers to apparatus for capturing digital image data, an Image capture device may be one or both of: a two dimensional camera (sometimes referred to as “2D”) or a three dimensional camera (sometimes referred to as “3D”). In some exemplary embodiments an image capture device includes a charged coupled device (“CCD”) camera.

As used herein, Production Media Ingest refers to the collection of image data and input of image data into storage for processing, such as Transcoding and Caching. Production Media Ingest may also include the collection of associated data, such a time sequence, a direction of image capture, a viewing angle, 2D or 3D image data collection.

As used herein, Vantage Point refers to a location of Image Data Capture in relation to a location of a performance.

As used herein, Directional Audio refers to audio data captured from a vantage point and from a direction such that the audio data includes at least one quality that differs from audio data captured from the vantage and a second direction or from an omni-direction capture.

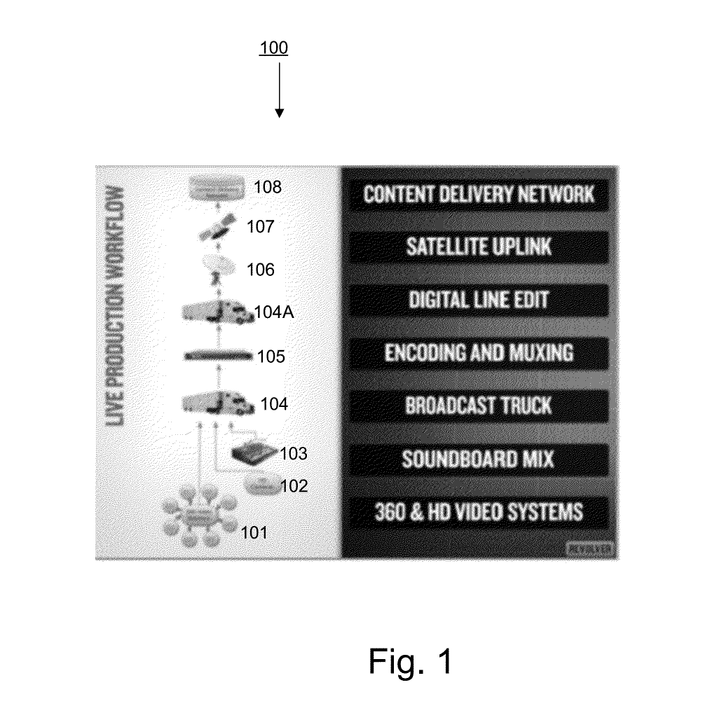

Referring now to FIG. 1, a Live Production Workflow diagram is presented 100 with components that may be used to implement various embodiments of the present invention. Image capture devices 101-102, such as for example, one or both of 360 degree camera arrays 101 and high definition camera 102 may capture image date of an event. In preferred embodiments, multiple vantage points each have both a 360 degree camera array 101 and at least one high definition camera 102 capturing image data of the event. Image capture devices 101-102 may be arranged for one or more of: planer image data capture; oblique image data capture; and perpendicular image data capture. Some embodiments may also include audio microphones to capture sound input which accompanies the captured image data.

Additional embodiments may include camera arrays with multiple viewing angles that are not complete 360 degree camera arrays, for example, in some embodiments, a camera array may include at least 120 degrees of image capture, additional embodiments include a camera array with at least 180 degrees of image capture; and still other embodiments include a camera array with at least 270 degrees of image capture. In various embodiments, image capture may include cameras arranged to capture image data in directions that are planar or oblique in relation to one another.

At 103, a soundboard mix may be used to match recorded audio data with captured image data. In some embodiments, in order to maintain synchronization, an audio mix may be latency adjusted to account for the time consumed in stitching 360 degree image signals into cohesive image presentation.

At 104, a Broadcast Truck includes audio and image data processing equipment enclosed within a transportable platform, such as, for example, a container mounted upon, or attachable to, a semi-truck, a rail car; container ship or other transportable platform. In some embodiments, a Broadcast Truck will process video signals and perform color correction. Video and audio signals may also be mastered with equipment on the Broadcast Truck to perform on-demand post-production processes.

At 105, in some embodiments, post processing may also include one or more of: encoding; muxing and latency adjustment. By way of non-limiting example, signal based outputs of HD cameras may be encoded to predetermined player specifications. In addition, 360 degree files may also be re-encoded to a specific player specification. Accordingly, various video and audio signals may be muxed together into a single digital data stream. In some embodiments, an automated system may be utilized to perform muxing of image data and audio data.

At 104A, in some embodiments, a Broadcast Truck or other assembly of post processing equipment may be used to allow a technical director to perform line-edit decisions and pass through to a predetermined player's autopilot support for multiple camera angles.

At 106, a satellite uplink may be used to transmit post process or native image data and audio data. In some embodiments, by way of non-limiting example, a muxed signal may be transmitted via satellite uplink at or about 80 megabytes (Mb/s) by a commercial provider, such as, PSSI Global™ or Sureshot™ Transmissions.

In some venues, such as, for example events taking place at a sports arena a transmission may take place via Level 3 fiber optic lines, otherwise made available for sports broadcasting or other event broadcasting. At 107 Satellite Bandwidth may be utilized to transmit image data and audio data to a Content Delivery Network 108.

As described further below, a Content Delivery Network 108 may include a digital communications network, such as, for example, the Internet. Other network types may include a virtual private network, a cellular network, an Internet Protocol network, or other network that is able to identify a network access device and transmit data to the network access device. Transmitted data may include, by way of example: transcoded captured image data, and associated timing data or metadata.

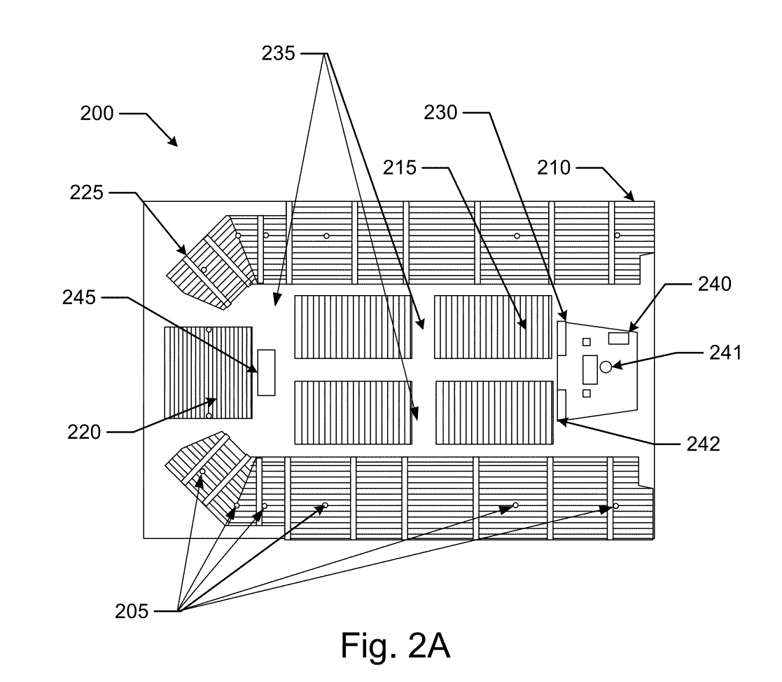

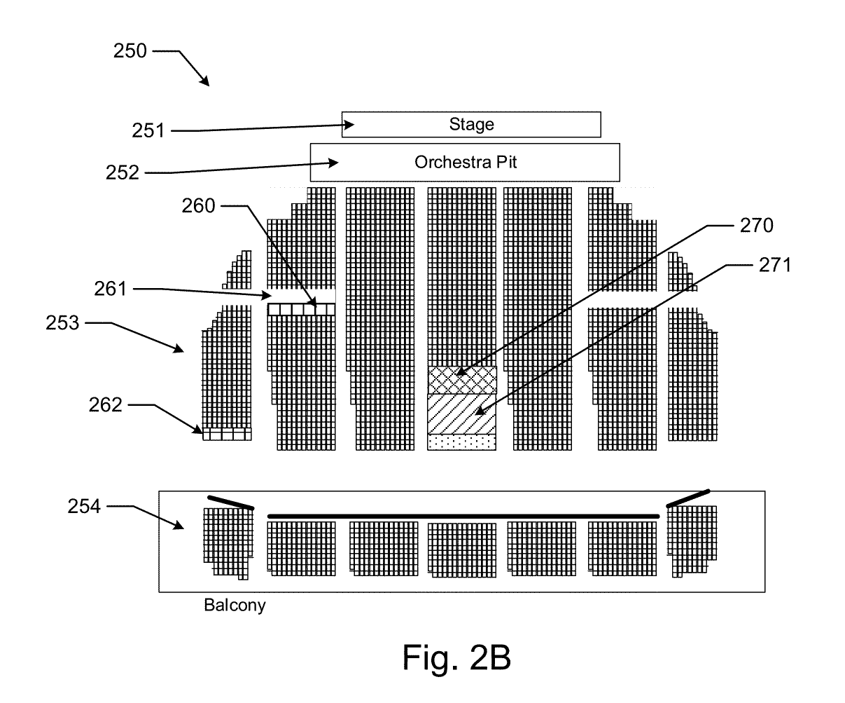

Referring to FIGS. 2A and 2B, the placement of audio capture devices may be illustrated for exemplary venues 200 and 250. The differences in the design of the two venues may be observed in reference to the top down design depictions. In a general perspective the types of venues may vary significantly and may include rock clubs, big rooms, amphitheaters, dance clubs, arenas and stadiums as non-limiting examples. Each of these venue types and perhaps each venue within a type may have differing acoustic characteristics and different locations within a venue.

At exemplary venue 200 a depiction of a stadium venue may be found. A stadium may include a large collection of seating locations of various different types. There may be seats such as those surrounding region 215 that have an unobstructed close view to the stage or other performance venue. The audio characteristics of these locations may be relatively pure as well since the distance from amplifying equipment is minimal. Other seats such as region 210 may have a side view of the stage or performance venue 230. Depending on the nature of the deployment of audio amplifying equipment and of the acoustic performance of the venue setting, such side locations may receive a relatively larger amount of reflected and ambient noise aspects compared to the singular performance audio output. Some seating locations such as region 225 may have obstructions including the location of other seating regions. These obstructions may have both visual and audio relevance. At 220, a region may occur that is located behind and in some cases obstructed by venue control locations such as sound and lighting control systems 245. The audio results in such locations may have impact of their proximity to the control locations. The venue may also have aisles such as 235 where pedestrian traffic may create intermittent obstruction to those seating locations there behind. There may be acoustic and background noise aspects to such obstruction as well as the visual related obstructive effects.

In some embodiments, the location of recording devices may be designed to include different types of seating locations. There may be aspects of a stadium venue that may make a location undesirable as a design location for audio capture. At locations 205 numerous columns are depicted that may be present in the facility. The columns may have acoustic impact but may also afford mounting locations for audio recording equipment where an elevated location may be established without causing an obstruction in its own right. There may be other features that may be undesirable planned audio capture locations such as behind handicap access, behind aisles with high foot traffic, or in regions where external sound or other external interruptive aspects may impact a desired audio capture.

The stage or performance venue 230 may have numerous aspects that affect audio collection. In some examples, the design of the stage may place performance specific effects on a specific venue. For example, the placement of speakers, such as that at location 242 may define a dominant aspect of the live audio experienced at a given location within the venue. The presence of performance equipment such as, in a non-limiting sense, drum equipment 241 may also create different aspects of the sound profile emanating from the stage. There may be sound control and other performance related equipment on stage such as at 240 that may create specific audio and audio retention based considerations. It may be apparent that each venue may have specific aspects that differ from other venues even of the same type, and that the specific stage or performance layout may create performance specific aspects in addition to the venue specific aspects.

A stadium venue may have rafters and walkways at elevated positions. In some embodiments such elevated locations may be used to support or hang audio devices from. In some embodiments, apparatus supported from elevated support positions such as rafters may be configured to capture audio data while moving.

At exemplary venue 260 in FIG. 2B, a depiction of a big room venue may be found. As mentioned there are numerous types of different venues, a big room demonstrates how some fundamental aspects may differ between choices of optimal audio capture locations. In an exemplary sense, a big room may typically lack obstructive features such as columns and many types of railings. And, the acoustic surfaces located in the venue may be designed and constructed to offer good acoustic performance at many of the locations within the venue. From a different perspective, the seats in a big room may not have the amount of elevation present in a stadium setting and, therefore, may quickly have obstructive aspects of the spectator population. As well, the presence of an audio capture apparatus may itself create more interruptions in the flatter setting of a big room to spectators. Referring again to FIG. 2B, in a big room at 260 there may be regions that have relatively larger ambient noise potential due to the movement of pedestrians in aisles such as 261. There may also be a sound and lighting control area such as item 270 which may impact audio conditions at region 271 in an exemplary sense. In some embodiments, the locations behind such sound and control regions may have relatively significant amounts of obstruction. On the other hand, the sound and lighting aspects of the production may have optimal characteristics in regions close to control locations. These factors may create regions in a particular venue that are planned or unplanned for audio capture.

In some embodiments, a big room venue may have a stage 251 with a neighboring Orchestra pit 252. The nature of an orchestra pit type sound creation may affect the acoustics of a performance and the nature of designed audio capture. There may also be special seating locations such as at 262 which for example may be a handicap seating location that may cause consideration of audio capture aspects. These various locations may occur in a first level 253 that in some embodiments may be termed an orchestra level. The venue may have one or more elevated seating regions such as a balcony region at 254 as an example. The elevation of a balcony may move a spectator some distance away from a stage or performance location; however, on the other hand, it may provide a unique perspective on performance sound as well due to the elevated perspective. These factors may have a role in determining the design locations for audio capture apparatus according to the inventive art herein.

It may be apparent that specific venues of a particular venue type may have different characteristics relevant to the placement of audio capture apparatus. It may be further apparent that different types of venues may also have different characteristics relevant to the placement of audio capture apparatus. In a similar vein, since the location of audio equipment may in some embodiments mirror the placement of image capture apparatus, the aspects of a venue related to image capture may create default locations for audio capture. In some embodiments, the nature and location of regions in a specific venue may be characterized and stored in a repository. In some embodiments, the venue characterization may be stored in a database. The database may be used by algorithms to present a display of a seating map of a specific venue along with characteristics that may be positive or negative for the audio characteristics of the venue. In some embodiments, the display may be made via a graphical display station connected to a processor.

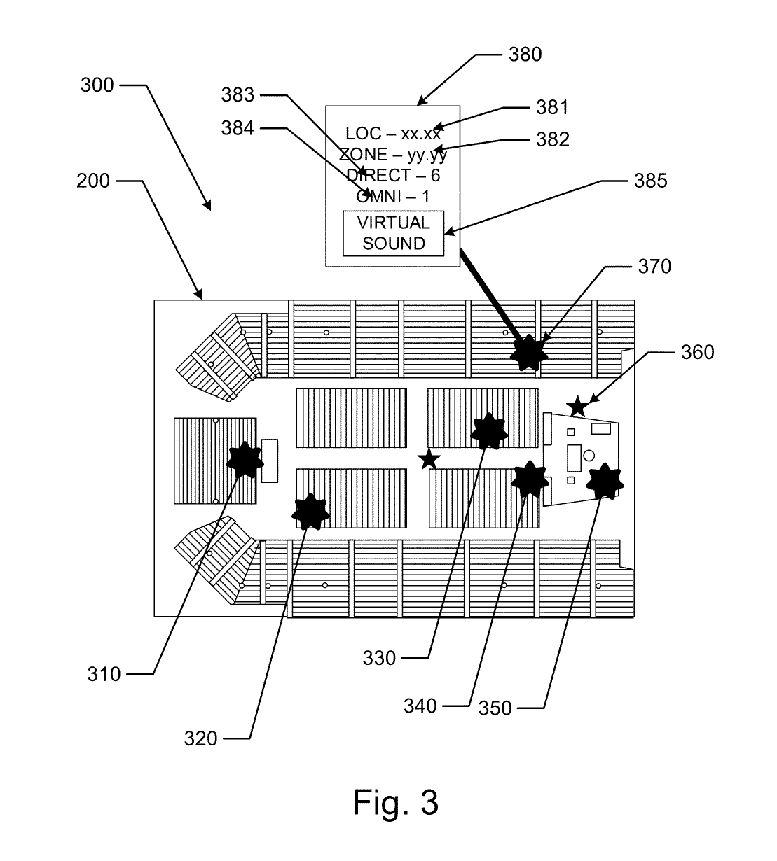

Referring to FIG. 3 item 300, a representation of a specific exemplary venue as demonstrated at 200 that may be presented to a viewer may be found where specific designed regions relating to audio capture may be indicated therein, such as the star at 310. The star at 310 may represent a particular audio capture type or a combination of audio capture equipment being located proximate to a sound control region as previously discussed. In addition, in an exemplary fashion there may be representations (such as the difference between a star at 360 and a star of the type at 310 that may indicate the different type of audio capture apparatus at the location. The stars at locations 310, 320, 330, 340, 350 and 370 may represent exemplary omni directional audio collection apparatus and 360 may represent an exemplary directional audio collection apparatus in a non-limiting example. In some embodiments, the presentation may be made in a manner that allows the user to interact with the defined locations by actions such as clicking a button while a cursor is located over an element of interest such as one of these stars, or by the action of moving the cursor over the element of interest as well.

At the star with the location 370, an example of a menu presentation at 380 that may be included in the graphical representation of the venue design may be found. There may be other examples of venue specific items that may be displayed and may have activity upon selecting them. For example, active points for viewer interaction may include columns, stage sets, positions of performers, entrances and exits, layout of venue seating, elevations of venue seating, multi-level venue seating, and changes in venue layout for specific events.

Referring still to FIG. 3, the representation of each of the highlighted aspects of a venue may include a feature where a virtual representation of the element may be presented to the user. In some exemplary embodiments, when an active element is activated by a means, the display of relevant data associated with the element may be presented to the user as depicted at menu 380. Included in the display of associated information relating to the element may be an active element that may allow for audio representations of the sound aspects of the highlighted location at 385. The type of data that may be included in the menu presentation to the viewer may be large and flexible and in a non-limiting exemplary sense may include positional reference data 381, elevation 382, type of sound capture devices at the location for directional microphones 383 and omni directional microphones 384. Other reference data may be presented including for example a unique hashtag reference to the location that may be useful for communication of a location in media, or social media as examples.

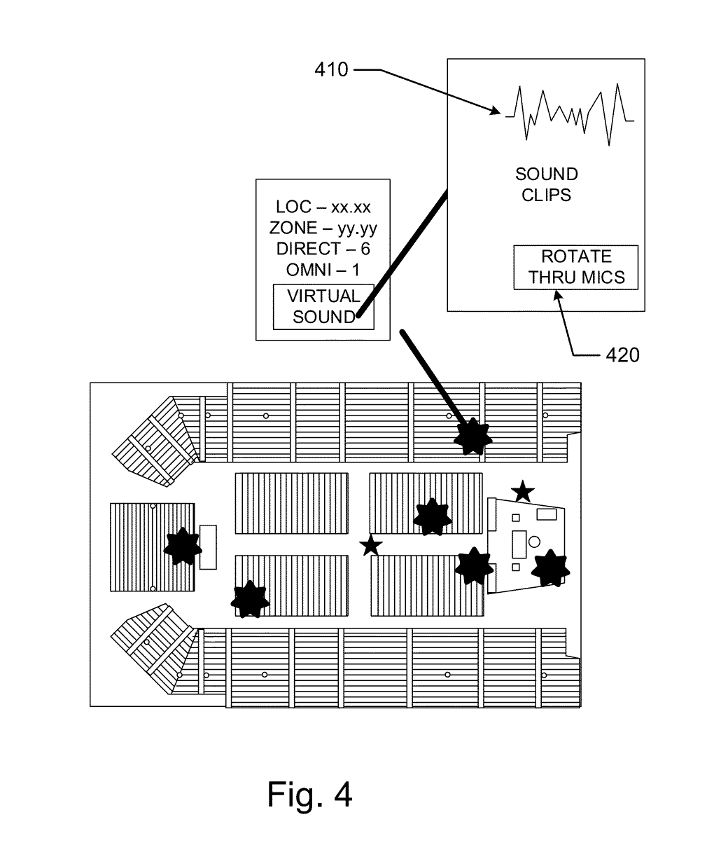

If a user activates the virtual sound representation element at 385, in some embodiments a playback of a virtual representation of the audio aspects at the element may be displayed. Referring to FIG. 4, in some embodiments the virtual representation of the location may include a graphic frequency depiction of an exemplary audio clip may be displayed at 410. In other embodiments, the representation may be a computer generated depiction of a standard audio clip from a location. At 420, in some embodiments and for some view related data there may be a function to rotate through the various directional and omni-direction capture devices from the point of interest. For those embodiments that contain social media reference identification, sound clips or textual descriptions from internet or social media sources of the point of interest may be displayed.

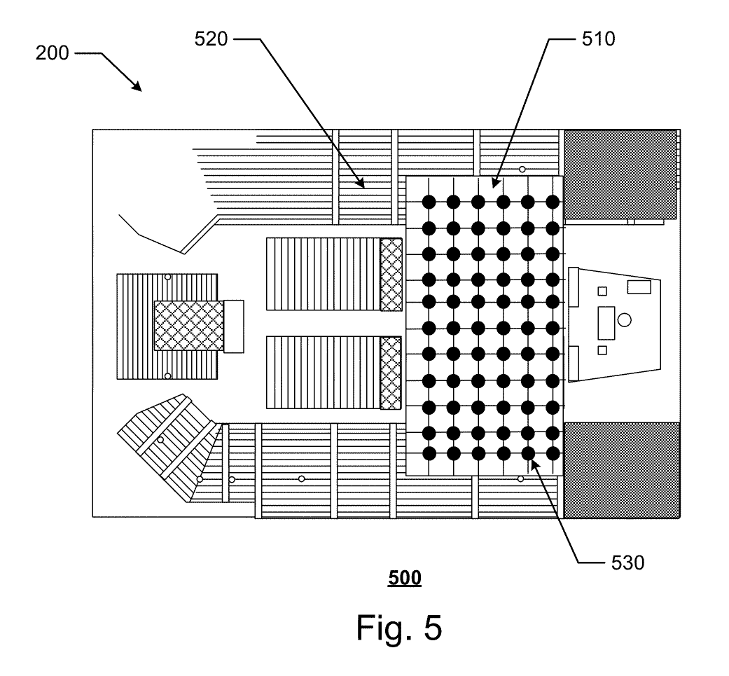

Referring to FIG. 5, at 500 another depiction of the exemplary venue 200 may be found where a grid of microphones may be deployed for audio capture. A grid 510 of microphones 530 may be deployed in the arena. An individual spectator location may be represented at 520. In some embodiments, there may be numerous ambient noise sources such as reflections, echoes and other background noise that may be picked up at location 520 in addition to audio emanating from the performance. Instead of placing an audio recording device, or perhaps in addition to placing an audio device at location 520, the captured sound from the grid 510 of microphones may be algorithmically treated to simulate the raw performance audio that would be found at location 520.

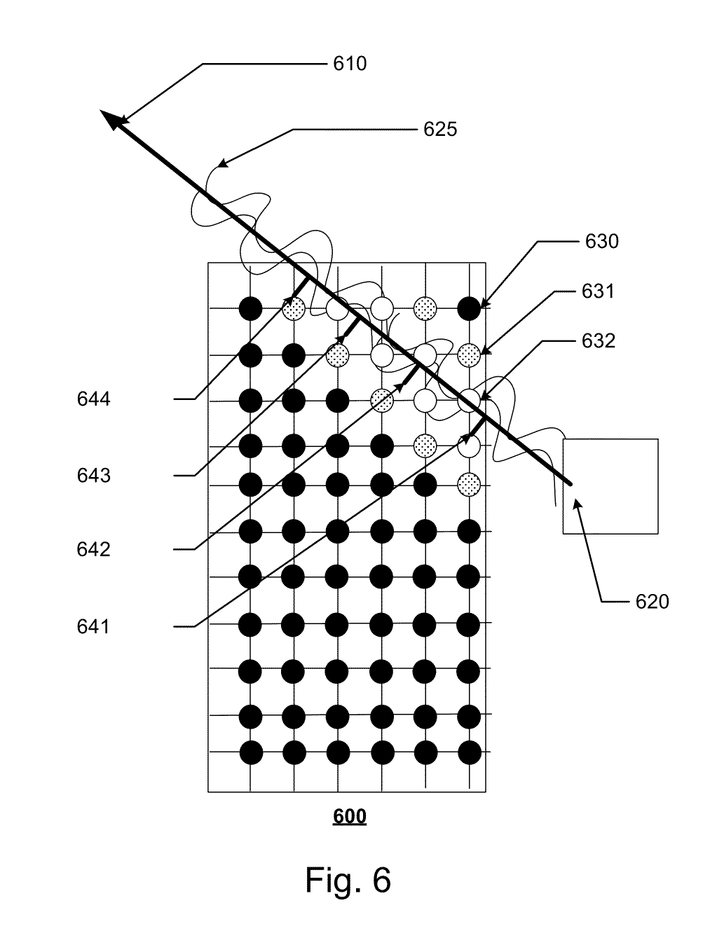

Referring to FIG. 6, 600 a close up of a representation of a grid of microphones may be depicted. The microphones in the grid may represent omnidirectional type microphones, or in some embodiments, directional microphones, collections of directional microphones arrayed in different directions or combinations of omnidirectional microphones and directional microphones.

In some embodiments the collected audio signals from the array may be used to synthesize an audio track for various purposes. Continuing with the depiction in FIG. 6, there may be embodiments where the synthesized audio result from performance sound may be calculated for an arbitrary location in the venue. There may be numerous sources of sound that are treated in the following manner, but for illustration purposes the depiction focus on one source 620 of sound which may be for example a speaker or a direct performance audio. The audio signals emanating from the source 620 may be depicted at 625. A particular direction along which the synthesized audio may be calculated may be indicated by the direction at 610. An algorithm may be used to add weighted combinations of the raw signal from selected microphones in an array. For example the microphone indicated with a pure white color such as 632 may have a heaviest weighting, microphones indicated with a shaded fill such as 631 may have a smaller weighting and the microphones indicated with solid fill such as 630 may have a zero weighting or not be included in the calculations. There may be numerous algorithmic approaches that may be applied to an array of microphones to synthesize audio tracks of various kinds. The array depicted in FIG. 6 may be characterized as a rectilinear organization of microphones, there may be numerous other arrangements including in a non limiting perspective radial orientations, non-linear arrangements, and irregularly spaced collections as examples.

The signal 625 emanating from a source 620 may have a time domain aspect to it as well. There may be a characteristic distance versus time relationship that occurs at a specific venue. For example, equivalent time intervals may be depicted at items 641, 642, 643 and 644. In the algorithmic treatments these characteristic time domain aspects may also be factored into the synthesis. For example, in a non-limiting sense noise improvement algorithms may utilize the time domain based on the weighting of microphones as discussed to extract or enhance the desired audio signals that are projected and travelling along a desired path based on both the directional weighting factors of the array and the time dependent progression of audio signal along a path. There may be numerous other aspects of the time dependency of the audio signal that may be important to synthesis algorithms.

The distance versus time relationship may be the characteristic speed of sound for a given frequency. There may be numerous environmental aspects that effect the speed such as the altitude of the venue, the atmospheric pressure, the relative humidity and the temperature of the location that a sound wave is traversing. There may be utility in recording these environmental factors as inputs to a synthetic algorithm. Alternatively or additionally it may be useful to include calibration protocols for the array in manners that allow for the combination of these factors into calibration factors. For example a controlled emanation of sound at a source 620 may be performed such that particular frequencies are emitted at defined times and the corresponding signal received in the array may allow for algorithmic extraction of calibration factors for the time domain effects. In addition the attenuation of sound in the environment of the array may also be calibrated in such calibration protocols. In some embodiments, the calibration protocol may be performed before a venue is utilized. In other embodiments, the calibration protocol may be performed during performances. In some embodiments, sound emanations that are outside of the audible range of humans may be used in calibration protocols.

In some embodiments, the representation of the specific venue may also include a representation of a specific stage or other performance venue may be superimposed with graphical depiction of historical data related to the venue. In some embodiments such a representation may aid in a process of designing audio capture locations for a future spectator event. There may be a large amount of historical data relating to a venue that may be useful. The process of designing the audio location may include accessing historical data which may be parsed into location specific data elements. As a non-limiting example, the frequency of occupation of locations within the venue may be depicted with color shadings representing frequency ranges. A designer may in some embodiments pick one or more locations based on the highest frequency of occupation as a non-limiting example. A similar type of process may result in an exemplary sense, where the historical data based on time to sale for a location may be used. Still further embodiments may result when ticket prices paid on primary or secondary markets are analyzed and displayed for their location dependence at a particular venue. There may be numerous other types of historical data that may be used in the processing of designing and selecting venue specific audio capture locations.

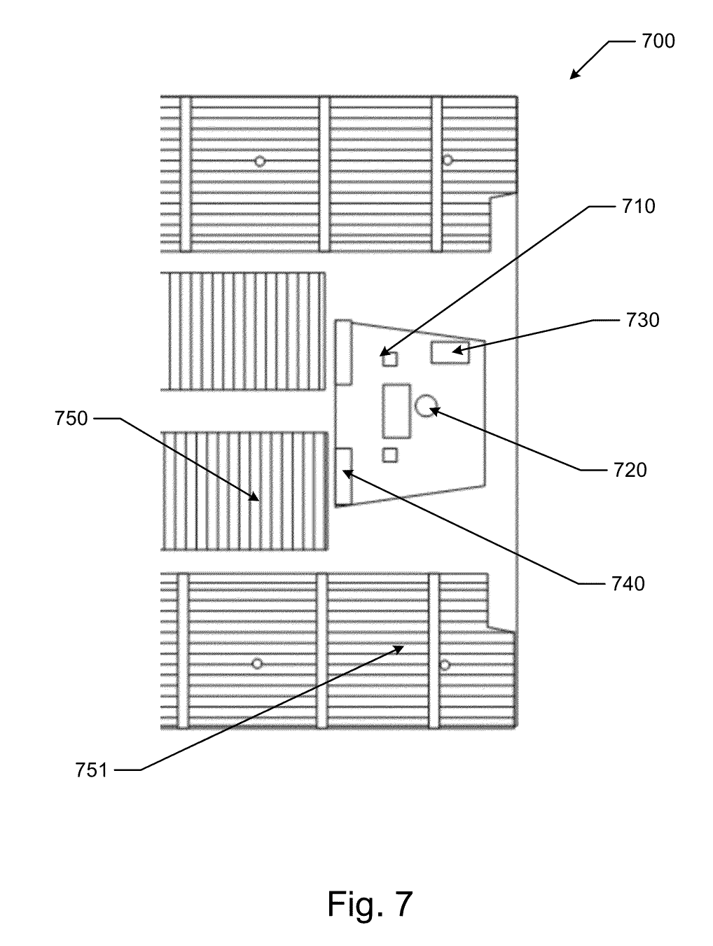

Referring to FIG. 7, 700 a depiction of some fundamentally different types of audio emanations that may be recorded according to the present invention are depicted. Audio signals may be present at a microphone worn by a performer at 710. These signals may be transmitted in wireless or wired format to a sound processing system 730. The raw input signal to the sound processing system 730 may be captured or an amplified and otherwise treated version of the signal may be captured from the sound processing system 730. Similar but different audio signals may be collected from performing equipment at a venue such as pickups on string instruments, pickups on drums, or pickups on other instruments. These signals 720 may have a raw signal aspect or may be fed to the sound processing system 730 where they may be recorded. Various collected audio signals may eventually be fed to a speaker system 740, the signals to these devices may be collected in some embodiments. Additionally, the various types of live audio collection means as have been described may be deployed in the venue. At 750, such recording equipment may be located in the venue proximate to the sound amplification apparatus and speaker system 740 such that those emanations dominate the recording. Alternatively, at 751 in remote and locations outside of the direct path of the emanations from the amplifying equipment audio capture equipment may be located where the collection of ambient sound sources such as audience generated sound, reflections of sound within the venue and the like may be present in the captured audio information to a larger degree.

In some embodiments, the audio collection may occur at designed pointes based on acoustic considerations alone. In addition, there may be video collection apparatus that are deployed within a venue. In some embodiments, audio collection may be performed at these video collection points alone or at these locations in addition to other audio collection based locations. For example there may be camera locations that collect visual data from multiple directions up to a full 360 degree perspective. At the same locations, microphones may be configured to captures omni-directional audio or directional audio that correlates to the directions of video capture. In some or all of the embodiments, it may be possible to record the audio information in such a manner that it facilities play back in various formats including stereo or surround sound as non-limiting examples.

There may also be locations of audio collection that are placed due to unique vantage points of the video and or audio aspects such as locating equipment at peripheries of the stage, in waiting areas off stage or in other locations where video and audio of unique perspectives may be occurring. These collection locations may be useful to emulate, display or simulate aspects of a live experience.

In some embodiments, audio collection equipment may be placed in numerous locations within a venue as has been described. There may be numerous manners to record or register the location of the equipment spatially. This recording of location may occur in a static manner or in a dynamic manner. In a non-limiting sense, microphone locations may be recorded before a performance by various triangulation manners including in a non-limiting perspective the collection of laser reflection information from the devices. The devices may also in a non-limiting perspective be equipped with self-locating devices such as gps transponders or the like to record and/or transmit their location to a receiving means. Additionally, collected video recordings may be useful in determining the location of audio and video collection equipment, particularly if there are manners of identifying the equipment in a venue such as graphical indicators, characteristic sound or visual emanations from the recording devices or the use of radio frequency emanations such as from an RF-ID; all in a non-limiting perspective.

Apparatus

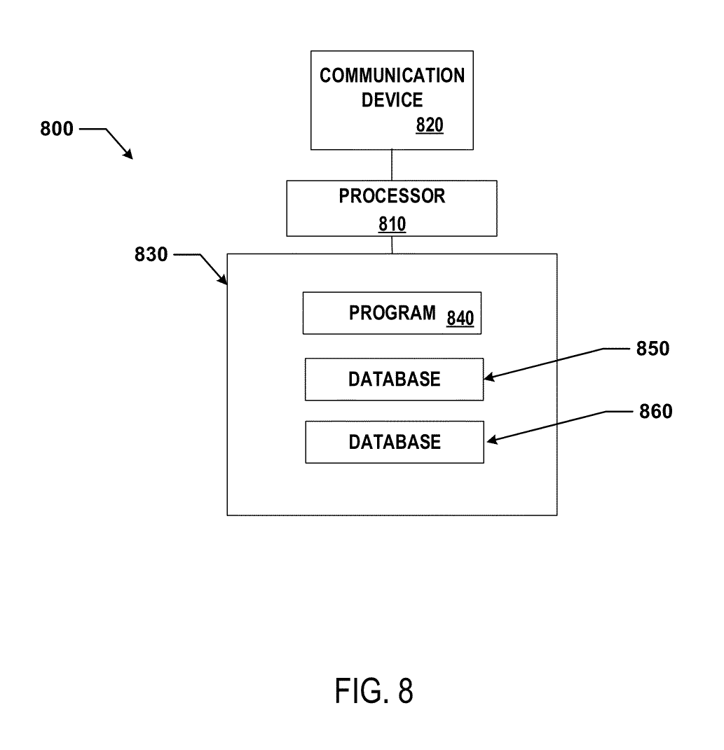

In addition, FIG. 8 illustrates a controller 800 that may be utilized to implement some embodiments of the present invention. The controller may be included in one or more of the apparatus described above, such as the Revolver Server, and the Network Access Device. The controller 800 comprises a processor 810, such as one or more semiconductor based processors, coupled to a communication device 820 configured to communicate via a communication network (not shown in FIG. 8). The communication device 820 may be used to communicate, for example, with one or more online devices, such as a personal computer, laptop or a handheld device.

The processor 810 is also in communication with a storage device 830. The storage device 830 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 830 can store a software program 840 for controlling the processor 810. The processor 810 performs instructions of the software program 840, and thereby operates in accordance with the present invention. The processor 810 may also cause the communication device 820 to transmit information, including, in some instances, control commands to operate apparatus to implement the processes described above. The storage device 830 can additionally store related data in a database 850 and database 860, as needed.

### Specific Examples of Equipment

Apparatus described herein may be included, for example in one or more smart devices such as, for example: a mobile phone, tablet or traditional computer such as laptop or microcomputer or an Internet ready TV.

The above described platform may be used to implement various features and systems available to users. For example, in some embodiments, a user will provide all or most navigation. Software, which is executable upon demand, may be used in conjunction with a processor to provide seamless navigation of 360/3D/panoramic video footage with Directional Audio—switching between multiple 360/3D/panoramic cameras and user will be able to experience a continuous audio and video experience.

Additional embodiments may include the system described for automatic predetermined navigation amongst multiple 360/3D/panoramic cameras. Navigation may be automatic to the end user but the experience either controlled by the director or producer or some other designated staff based on their own judgment.

Still other embodiments allow a user to participate in the design and placement of audio recording equipment for a specific performance at a specific venue. Once the audio capture apparatus is positioned and placed in use a user may record a user defined sequence of image and audio content with navigation of 360/3D/panoramic video footage, Directional Audio, switching between multiple 360/3D/panoramic cameras. In some embodiments, user defined recordations may include audio, text or image data overlays. A user may thereby act as a producer with the Multi-Vantage point data, including directional video and audio data and record a User Produced multimedia segment of a performance. The User Produced material may be made available via a distributed network, such as the Internet for viewers to view, and, in some embodiments further edit the multimedia segments themselves.

Directional Audio may be captured via an apparatus that is located at a Vantage Point and records audio from a directional perspective, such as a directional microphone in electrical communication with an audio storage device. Other apparatus that is not directional, such as an omni directional microphone may also be used to capture and record a stream of audio data; however such data is not directional audio data. A user may be provided a choice of audio streams captured from a particular vantage point at particular time in a sequence.

In some embodiments a User may have manual control. The User may be able to manually control by actions such as swipe or equivalent to switch between MVPs or between HD and 360. In still further embodiments, a user may interact with a graphical depiction of a specific venue where image and audio capture elements have been indicated thereupon.

In some additional embodiments, an Auto launch Mobile Remote App may launch as soon as video is transferred from iPad to TV using Apple Airplay. Using tools, such as, for example, Apple's Airplay technology, and a user may stream a video feed from iPad or iPhone to a TV which is connected to Apple TV. When a user moves the video stream to TV, automatically mobile remote application launches on iPad or iPhone is connected/synched to the system. Computer Systems may be used to displays video streams and switches seamlessly between 360/3D/Panoramic videos and High Definition (HD) videos.

In some embodiments that implement Manual control, executable software may allow a user to switch between 360/3D/Panoramic video and High Definition (HD) video without interruptions to a viewing experience of the user. The user may be able to switch between HD and any of the multiple vantage points coming as part of the panoramic video footage.

In some embodiments that implement Automatic control, a computer may implement a method (software) that allows its users to experience seamlessly navigation between 360/3D/Panoramic video and HD video. Navigation is either controlled a producer or director or a trained technician based on their own judgment.

Manual Control and Manual Control systems may be run on a portable computer such as a mobile phone, tablet or traditional computer such as laptop or microcomputer. In various embodiments, functionality may include: Panoramic Video Interactivity, Tag human and inanimate objects in panoramic video footage; interactivity for the user in tagging humans as well as inanimate objects; sharing of these tags in real time with other friends or followers in your social network/social graph; Panoramic Image Slices to provide the ability to slice images/photos out of Panoramic videos; real time processing that allows users to slice images of any size from panoramic video footage over a computer; allowing users to purchase objects or items of interest in an interactive panoramic video footage; ability to share panoramic images slides from panoramic videos via email, sms (smart message service) or through social networks; share or send panoramic images to other users of a similar application or via the use of SMS, email, and social network sharing; ability to “tag” human and inanimate objects within Panoramic Image slices; real time “tagging” of human and inanimate objects in the panoramic image; allowing users to purchase objects or items of interest in an interactive panoramic video footage; content and commerce layer on top of the video footage—that recognizes objects that are already tagged for purchase or adding to user's wish list; ability to compare footage from various camera sources in real time; real time comparison panoramic video footage with associated audio recordings from multiple cameras captured by multiple users or otherwise to identify the best footage based on aspects such as visual clarity, audio clarity, lighting, focus and other details; recognition of unique users based on the user's devices that are used for capturing the video footage (brand, model #, MAC address, IP address, etc.); radar navigation of which camera footage is being displayed on the screens amongst many other sources of camera and audio feeds; navigation matrix of panoramic video and audio viewports that in a particular geographic location or venue; user generated content that can be embedded on top of the panoramic video and audio that maps exactly to the time codes of video feeds; time code mapping done between production quality video feed and user generated video feeds; user interactivity with the ability to remotely vote for a song or an act/song while watching a panoramic video and effect outcome at venue. Software allows for interactivity on the user front and also ability to aggregate the feedback in a backend platform that is accessible by individuals who can act on the interactive data; ability to offer “bidding” capability to panoramic video audience over a computer network, bidding will have aspects of gamification wherein results may be based on multiple user participation (triggers based on conditions such # of bids, type of bids, timing); Heads Up Display (HUD) with a display that identifies animate and inanimate objects in the live video feed wherein identification may be tracked at an end server and associated data made available to front end clients.

### CONCLUSION

A number of embodiments of the present invention have been described. While this specification contains many specific implementation details, they should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

1. A method of capturing venue specific audio recordings of an event, the method comprising the steps of:
obtaining spatial reference data for a specific venue;
creating a digital model of the specific venue;
selecting multiple vantage points for audio capture in the specific venue; and
placing two or more of omni-directional audio capture devices and directional audio capture devices at selected multiple vantage points, wherein the data is synchronized such that a user may listen to audio data from the multiple vantage points.

2. The method of claim 1 additionally comprising the steps of:
presenting the digital model to a first user, wherein the presentation supports the selecting multiple vantage points for audio capture.

3. The method of claim 2 wherein the presentation includes venue specific aspects.

4. The method of claim 3 wherein the venue specific aspects include one or more of seating locations, aisle locations, obstructions to viewing, performance venue layout, sound control apparatus, sound projection apparatus, and lighting control apparatus.

5. The method of claim 4 wherein the selecting multiple vantage points is performed by interacting with a graphical display apparatus, wherein the interacting involves placement of a cursor location and selecting of the location with a user action.

6. The method of claim 5 wherein the user action includes one or more of clicking a mouse, clicking a switch on a stylus, engaging a keystroke, or providing a verbal command.

7. The method of claim 3 additionally comprising the step of presenting the digital model to a second user, wherein the second user employs the digital model to locate selected audio capture locations in the venue.

8. The method of claim 7 additionally comprising the steps of:
recording audio data from selected audio capture location;
utilizing a soundboard to mix collected audio data with image data; and
performing on demand post processing on audio and image data in a broadcast truck.

9. The method of claim 8 additionally comprising the step of:
communicating data from the broadcast truck utilizing a satellite uplink.

10. The method of claim 9 additionally comprising the step of:
transmitting at least a first stream of audio data to a content delivery network.

11. The method of claim 2 additionally comprising the step of:
obtaining venue specific historical data.

12. The method of claim 11 wherein the venue specific historical data comprises one or more parameters relating to primary price, secondary price, frequency of occupation, and rate of purchase.

13. The method of claim 12 wherein the venue specific historical data is used to create a first graphical layer of the model.

14. The method of claim 13 additionally comprising a step of:
choosing audio capture locations in the venue utilizing the first graphical layer.

15. The method of claim 14 wherein the step of choosing audio capture locations in the venue utilizing the presentation of the graphical layer is performed automatically.

16. A method of collecting audio information from a performance, the method comprising:
configuring an array of audio collection devices in a venue;
synchronizing a collection of audio data from two or more of the audio collection devices in the array to a time based index; and
recording audio signals and synchronization signals from at least two of the audio collection devices from the array.

17. The method of claim 16 additionally comprising the steps of:
processing the at least two collected audio data with an algorithm to synthesize a second audio track.

18. The method of claim 17 wherein the algorithm weights the audio signal from a first audio data at a different level than the audio signal from a second audio data from the at least two collected audio data signals.

19. The method of claim 17 additionally wherein the algorithm utilizes the time based index of the audio signal from a first audio data and the time based index of the audio signal from a second audio data from the at least two collected audio data signals.

20. A method of capturing venue specific audio of an event, the method comprising the steps of:
obtaining spatial reference data for a specific venue;
creating a digital model of the specific venue;
presenting the digital model to a first user;
selecting multiple vantage points for audio capture in the specific venue, wherein the presenting the digital model supports the selecting multiple vantage points for audio capture in the specific venue;
placing two or more of omni-directional audio capture devices and directional audio capture devices at selected multiple vantage points; wherein the data is synchronized such that a user may perceive audio data from the multiple vantage points;
recording audio data from selected audio capture locations;
utilizing a soundboard to mix collected audio data with image data;
performing on demand post processing on audio and image data in a broadcast truck;
communicating data from the broadcast truck utilizing a satellite uplink; and
transmitting at least a first stream of audio data to a content delivery network.
